(19) United States
(12) Patent Application Publication
(10) Pub. No.: US 2003/0131467 A1
(43) Pub. Date: Jul. 17, 2003

(54) Method and device for manufacturing of saddle coils

(76) Inventors: Walter Kogler, Heimstetten (DE); Harry Munack, Heimstetten (DE)

Correspondence Address: SUGHRUE MION, PLLC, 1010 EL CAMINO REAL, SUITE 300, MENLO PARK, CA, 94025, US

(21) Appl. No.: 10/275,596

(22) PCT Filed: May 11, 2001
(86) PCT No.: PCT/EP01/05401

(30) Foreign Application Priority Data
May 17, 2000 (EP) 001105162

(51) Int. Cl. H01F 7/06

(52) U.S. Cl. 29/605; 29/602.1

(57) ABSTRACT

The invention provides a method of manufacturing a saddle coil. The method comprises the step of winding a conductor around a winding core (12) which is at least partially inclined. During this step an intermediate coil is formed. The intermediate coil is bent to form the saddle coil.

### FIELD OF THE INVENTION

The invention relates to saddle coils and to methods of manufacturing saddle coils. In particular, this invention relates to saddle coils used in charged particle beam devices.

### BACKGROUND OF THE INVENTION

Charged particles placed in an electrical or magnetic field experience forces acting upon them. In an electrical field, the forces are proportional to the field strength and are acting in the direction of the field vector. In a magnetic field, the forces on the charged particle moving through it are also proportional to the field strength, however, they are acting perpendicular to the field vector and to the velocity vector of the particle.

These field properties are used in a variety of charged particle beam devices to influence the path of the particles. Familiar examples of such devices are oscilloscopes, computer monitors, television picture tubes, charged particle microscopes etc. In general, a charged particle beam device comprises a particle source and one or more lenses which usually operate in vacuum. Since the diameter of the beam coming from the particle source is in many applications too large, the lenses are used to reduce the diameter and to focus the beam. Further, in charged particle beam devices, deflection systems are often used to scan the beam along a line and then displace the line position for the next scan so that a rectangular raster is generated on either a viewing screen or a specimen. A typical example of a deflection system is a scan coil which is positioned in close contact to the passing beam so that the magnetic field created by the scan coil influences the beam path.

In many applications the particle beam is guided through a cylindrical tube e.g. a cathode ray tube (CRT) or a shielding tube of charged particle microscopes. In order to provide for a deflection field close to the beam path, the coils are usually formed to adapt to the particular radius and/or shape of the tube. Such coils are called saddle coils. For charged particle devices, a saddle coil with an opening angle of about 120° is preferred. Saddle coils producing high accuracy magnetic deflection fields are also used in nuclear magnetic resonance devices (NMR). In view of their more complex three dimensional shape, the production of saddle coils is more elaborate and costly than the production of flat coils (see also P. W. Hawkes and E. Kasper, “Principles of Electron Optics”, Vol. 2, pp. 836-839, Academic Press, 1989).

In the state of the art, a variety of methods for producing saddle coils are known. In U.S. Pat. No. 5,409,558 (Takahashi, Toshiba) a manufacturing method is disclosed according to which wires are placed in grooves formed in a first mold, so that the spatial arrangement of the saddle coils are determined by the positions of the grooves. This is done to locate the wires in predetermined positions and to achieve a specific spatial arrangement of the saddle coils.

In U.S. Pat. No. 5,773,724 (Unterseh, Endress+Hauser) another method of manufacturing differently dimensioned saddle coils is described. A prefabricated wire having a first insulating-varnish coating directly thereon and a second insulating-varnish coating applied to the first coating, the second coating having a baking temperature lower than the softening point of the first coating. The coil is wound on a coil form to form a flat coil, the coil from being a prefabricated part of a flexible plastic which is dimensionally stable at the baking temperature. The flat coil is then fitted together with the coil form to the curved surface of a corresponding dummy to form a still dimensionally unstable saddle coil. Then a current whose strength is so chosen that the baking temperature is at least reached is sent through the saddle coil until the second insulating-varnish coatings are bonded, baked or fused to each other. After the current has been switched off, the second insulating-varnish coating solidifies to a dimensionally stable saddle coil.

U.S. Pat. No. 5,994,704 (Nakasuji, Nikon) discloses a method of manufacturing electromagnetic deflectors. A pair of looped shaped channels are formed opposite each other in the sides of a cylindrical insulating cylinder. An electrically conductive material is embedded in the channels to form a set of opposing coils operable to deflect a charged particle beam passing through the cylinder. The cylinders are placed concentrically inside a cylindrical outer casing made of ferromagnetic material such as a ferrite to make an electromagnetic deflector.

The manufacturing methods known in the art still have the disadvantage of requiring complicated process steps and/or various molds for the saddle coils.

### SUMMARY OF THE INVENTION

The present invention intends to provide an improved saddle coil and a method for manufacturing a saddle coil to overcome at least some of the problems associated with saddle coils and manufacturing processes known in the state of the art. According to one aspect of the present invention, there is provided a method for manufacturing saddle coils as specified in independent claims 1 and 8.

According to a first aspect, the method comprises the step of winding a conductor around a winding core which is at least partially inclined. During this step an intermediate coil is formed. This intermediate coil is then bent to form the saddle coil. Thereby, conductor in the context of this invention comprises all continuous length of conductive material with all kind of circumferences which can be wound around a given shaped body. In particular, it includes wires, cables, filaments, etc.

The at least partially inclined section of the winding core will cause the intermediate coil, which is formed by winding a wire around the core, to have a corresponding inclined section. Due to the inclined section, the windings will have an increasing wire length. If the intermediate coil is bent to form the saddle coil, the longer windings will have sufficient wire length to allow for a plastic deformation during the bending step.

According to a further aspect of the present invention there is provided a saddle coil as specified in independent claim 9. Thereby, the inclined section of the intermediate coil acts as a wire length reservoir during the bending step. Windings of the intermediate core with a bigger circumference can be bent further than those with a smaller one.

Further advantageous, features, aspects and details of the invention are evident from the dependent claims, the description and the accompanying drawings. The claims are intended to be understood as a first non-limiting approach of defining the invention in general terms.

According to a preferred aspect of the present invention, the winding core comprises at least two inclined sections. The corresponding inclined sections of the intermediate coil can cooperate to provide sufficient flexibility of the coil during the bending step. Advantageously, the at least two inclined sections of the winding core are located opposite to each other. If the bending is carried out in such a way that both inclined sections are displaced, the two reservoirs support each other in absorbing the stretching of the windings. It is particularly preferred to provide for the same inclined slope at the at least two inclined sections. Given a respective symmetry during the bending step, the saddle coil can be formed more evenly from the intermediate coil.

According to a further preferred aspect of the invention, the inclined sections of the winding core are straight. This allows to wind the conductor in such a way that a linear increase of wire length is achieved. A linear increase in wire length is advantageous during the bending step. It is further preferred to displace but not to bend the inclined side sections of the intermediate coil.

In another preferred method of manufacturing a saddle coil, the two core bow sections of the winding core are parallel to each other. It is even more preferred that the two core side sections and the two core bow sections are perpendicular to each other. If the intermediate coil has a higher symmetry it is easier to form a saddle coil which fits best to conical or cylindrical shaped parts such as lenses and shielding tubes placed around a charged particle beam. Thus, a highly accurate magnetic field can be created.

It is further preferred to form a flat intermediate coil. Compared with other shapes, a flat coil is a lot easier to manufacture.

According to another advantageous object, those parts of the intermediate coil which are not inclined are bent. The bending of certain parts of the intermediate coil causes stress in other parts of the coil which are displaced but not bent. The other parts preferably act as a wire length reservoir and thus have preferably a inclined cross section.

It is of particular advantage to use the saddle coils manufactured in accordance with this invention in charged particle beam devices. Primarily they are used for deflection systems where the distance of the coils from the optical axis of the charged particle device is limited either by the available space or where high deflection currents and a corresponding heat load have to be avoided. In these cases the homogeneity of the deflection field generated by planar coils is not sufficiently accurate in the neighborhood of the optical axis. This is desired for magnetic deflection systems employed for beam alignment and beam scanning devices. A preferred application is a magnetostatic beam separator used for splitting the primary charged particle beam from the secondary and backscattered charged particle beam [described in EP 0 917 177 A1 Korpuskularstrahlgerät].

The invention is also directed to methods for manufacturing the described saddle coil. It includes method steps for manufacturing every feature of the saddle coil. Furthermore, the invention is also directed to saddle coils manufactured according to the disclosed methods. The method steps may be performed by hand, by way of hardware components, a computer programmed by appropriate software, by any combination of the three or in any other manner.

### BRIEF DESCRIPTION OF THE DRAWINGS

Some of the above indicated and other more detailed aspects of the invention will be described in the following description and partially illustrated with reference to the figures. Therein:

FIG. 1a shows a winding tool with a partially inclined winding core for forming an intermediate coil.

FIG. 1b shows the winding tool of FIG. 1a, the winding tool being turned 90° ;

FIGS. 2a and 2b show top views of winding cores;

FIGS. 2c, 2d and 2e show straight, concave and convex inclined slopes of the winding core;

FIG. 3 shows a sectional view through an intermediate coil;

FIGS. 4a shows a front view of a bending tool with an intermediate coil placed between mold and stamp;

FIG. 4b shows a side view of a bending tool with an intermediate coil placed between mold and stamp;

FIGS. 5a to 5d show top views of a variety of intermediate coil;

FIG. 6 shows a top view of a saddle coil according to the invention;

FIG. 7 shows a side view of the saddle coil according to FIG. 6 seen from the perspective of line A; and

FIG. 8 shows a side view of the saddle coil according to FIG. 6 seen from the perspective of line B.

In the figures, like reference numbers refer to like elements.

### DESCRIPTION OF THE PREFERRED EMBODIMENTS

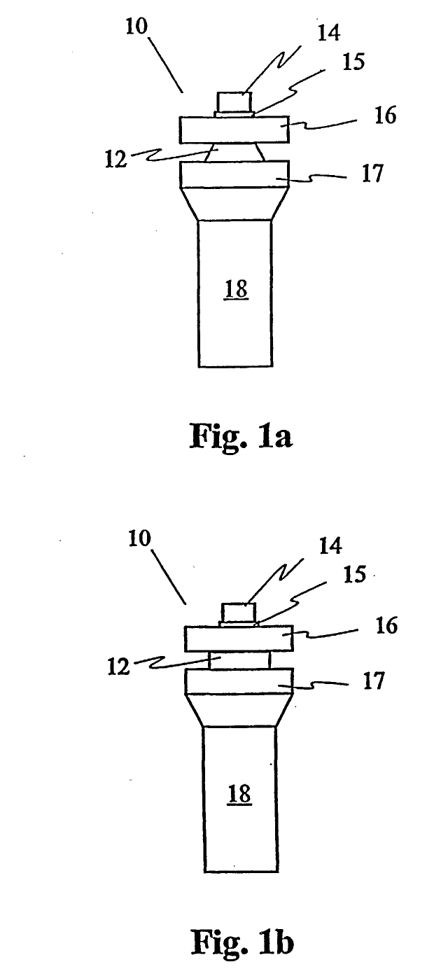

FIG. 1a shows schematically an exemplary tool 10 used for winding an intermediate coil 3. Sandwiched between an upper holding plate 16 and a lower holding plate 17 is winding core 12. The lower holding plate 17 is placed onto support shaft 18. The support shaft 18 can be provided with a central rod extending from the top of the shaft. The rod is inserted into a corresponding opening in lower support plate 17. Then, winding core 12 with its fixation opening 22 is placed over the rod. The last part located on the rod is upper holding plate 16. A threading at the top end of the rod interacts with nut 14 to fasten the winding core 12 tightly between the upper and the lower holding plate. Preferably, lower support plate 17 and support shaft 18 are formed as a single piece.

Alternatively to a rod emerging from shaft 18, fastener 14 can be a screw which is screwed into a bore hole provided in shaft 18. In both cases a tight fixation is preferred to prevent windings from gliding into the interface between winding core 12 and one of upper and lower holding plates 16,17. Advantageously, a washer 15 is placed between fastener 14 and upper holding plate 16.

The surface of the upper holding plate 16 facing the winding core 12 is advantageously provided with a slit. It starts at the outer rim and ends at the center of the upper holding plate. The starting end of the wire for the winding is inserted into the slit so that it does not exceed above the surface of the upper holding plate. Even so it is preferred to provide the upper holding plate 16 with the slit for inserting the wire, the slit can also be provided on lower support plate 17. An intermediate coil is manufactured e.g. by inserting the starting end of a wire into the slit until it reaches the triangular comer created by the upper holding plate 16 and the winding core 12. The wire is then wound around the winding core. After the first winding is completed, the second winding is started adjacent to the first one. The first layer of windings is accomplished if present winding does not fit between the pre ultimate winding and the lower holding plate 17. From that point on, the next layer is formed into the opposing direction i.e. starting from the lower holding plate 17 towards the upper holding plate 16. The tension applied to the wire during the winding process, in combination with the inclined slope of the winding core, will cause a force directed towards the upper winding plate 16. Nevertheless, a respective slip can easily prevented by carefully winding the wire in the recess between two windings of the lower layer which will provide for sufficient friction. A fixing of several windings can also be achieved by using an insulating varnish around the wires. A heating step causes the varnish to melt and fixes the wires to each other. Alternatively, an appropriate solvent like alcohol can be provided between the wire layers.

The two holding plates 16, 17 act as upper and lower limitation of the intermediate coil which starts to build up with the completion of each consecutive winding layer. The last winding of each layer is firmly held in place by the preceding winding, the lower winding layer and one of the two holding plates. If the desired number of winding layers has been built up, the intermediate coil is completed. In some cases, the bent wires are sturdy enough to supply the resulting intermediate coil with sufficient stability so that no further process steps are necessary before detaching the intermediate coil from the winding tool 10. However, it is preferred to use insulating varnish and a heating step or an appropriate solvent like alcohol for providing additional stability to the completed intermediate coil.

To detach the intermediate coil from the winding tool 10, fastener 14 is loosened and upper holding plate 16 removed. Then, the intermediate coil can be detached, either together with winding core 10 or separately. For most applications, the detached intermediate coil is ready for further processing.

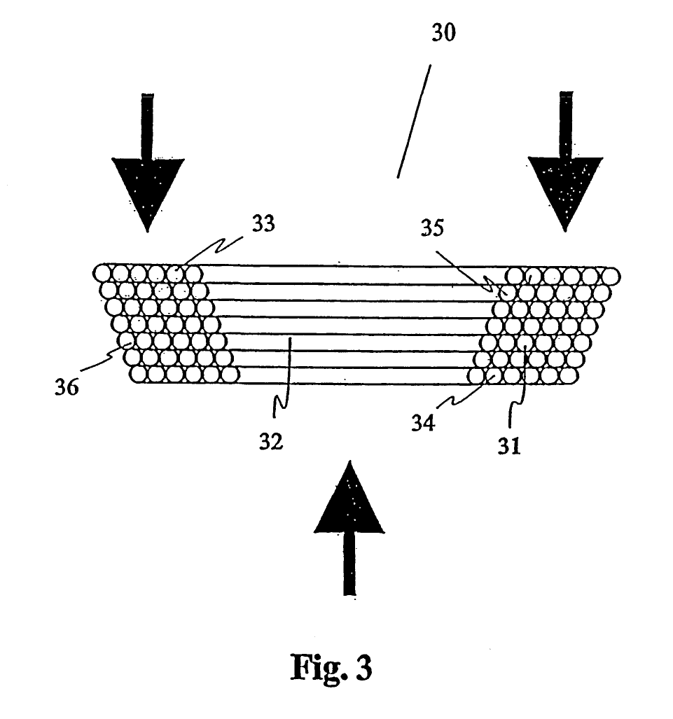

FIG. 1b shows the winding tool 10 of FIG. 1a. The winding tool 10 is turned 90° so that the inclined slopes of the winding core 12 are directed parallel to the surface of the drawing sheet. The winding core used in FIG. 1b is rectangular with two opposing inclined slopes and two opposing straight sections. Both, the inclined slopes and the straight sections are parallel to each other. The resulting shape of the formed intermediate coil will be discussed with reference to FIG. 3.

The winding of the conductor onto the winding core 12 can be carried out manually or automatically. For the automatic winding a high sophisticated CNC machine is not required, in general, a simple winding machine will do the job.

The winding tool for manufacturing the intermediate coil comprises a winding core 12 with at least one inclined section, a first holding plate for supporting the lower winding layers and a second holding plate for supporting the uppermost winding layer.

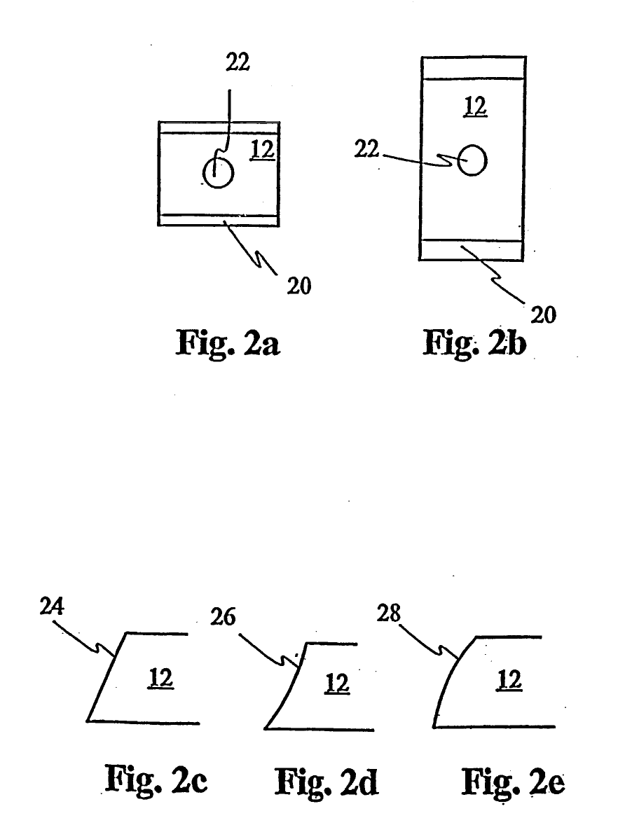

FIGS. 2a and 2b show a top view of two rectangular winding cores 12. Both winding cores comprise two inclined slopes opposing each other and parallel to each other. Together with two holding plates the winding core 12 forms a mold for manufacturing the intermediate coil which is made by winding a wire around it. In the embodiments shown, the inclined slopes are arranged perpendicular to the remaining two sides of the winding core 12. Depending on the material used for manufacturing the winding core, the four corners created by at the intersection of the inclined slopes 20 with the remaining two sides have sharp edges which could cause rupture of the wire wrapped with tension around it. Preferably, these edges are rounded to reduce the danger of wire damage.

A fixation opening 22 located in the center of the winding serves to accommodate either a rod attached to shaft 18 of the winding tool or a bolt of fastener 14. To avoid rotation of the winding core during the winding step, the fixation opening 22 is preferably non-circular. A square, a cross shaped or an elliptically shaped fixation opening for holding a guide member which fixes the winding core between two holding plates has the advantage of preventing circular movement of the winding core. However, the production of noncircular guide members engaging with corresponding fixation openings are more costly to produce.

The winding cores shown in FIGS. 2a and 2b have straight inclined sections and straight connecting sections. It is within the scope of this invention to also use curved sections which still allow a tight winding of the wire onto the winding core 12. FIGS. 2c to 2e show three side views of various inclined slopes of winding cores. The linearly inclined slope of FIG. 2c has the advantage of providing a linear increase in wire length. Nevertheless, the concave and the convex inclined slopes shown in FIG. 2d are still capable of forming a inclined section in the intermediate coil which can then act as a wire length reservoir during the bending step.

FIG. 3 shows a cross sectional view of an intermediate coil. The illustrated intermediate coil has been formed by winding a wire around a winding tool 12 which has two opposing inclined sections which run parallel to each other. The cross sectional view is taken along a line perpendicular to the inclined slopes of the intermediate coil. The drawing shows two rhombus shaped wire bundles which represent the N loops or windings 31 of a coil creating a specific magnetic field in the interior of that coil 32 or in its vicinity. Winding 34 is part of a winding layer with smaller circumferences in comparison with the larger circumferences of the windings of the winding layer represented by winding 33.

The intermediate coil 30 comprises a inclined slope 35 at its interior side. This slope was formed by winding the wires around the inclined part of winding core 12. A further inclined slope is located at the exterior part 36 of intermediate coil 30. These slopes results from a transposition of the interior slope created by the steady build up of intermediate coil 30. In practice, however, the transposition of the slope is not as perfect and clear as shown in FIG. 3. In most cases, small imperfections during the winding steps cause the diagonal line of the slopes to get reduced with the build up of each additional layer. From a certain number of layers on, the exterior side of the intermediate coil appears to be irregular.

The bending of intermediate coil 30 is achieved e.g. by applying a force to the winding layer with the big circumference at the position of the inclined sections. An opposing force is applied to the winding layer with the small circumference at positions which are distinct from the inclined sections. This results in. This results in a bending of the intermediate coil into a saddle coil by causing a bigger deformation of those wire loops belonging to the larger circumference layer as compared to the deformation of those wire loops which belong to the smaller circumference layer.

Preferably, one force is exclusively applied to the inclined sections of the intermediate coil and another force is exclusively applied to the non-inclined sections of the intermediate coil.

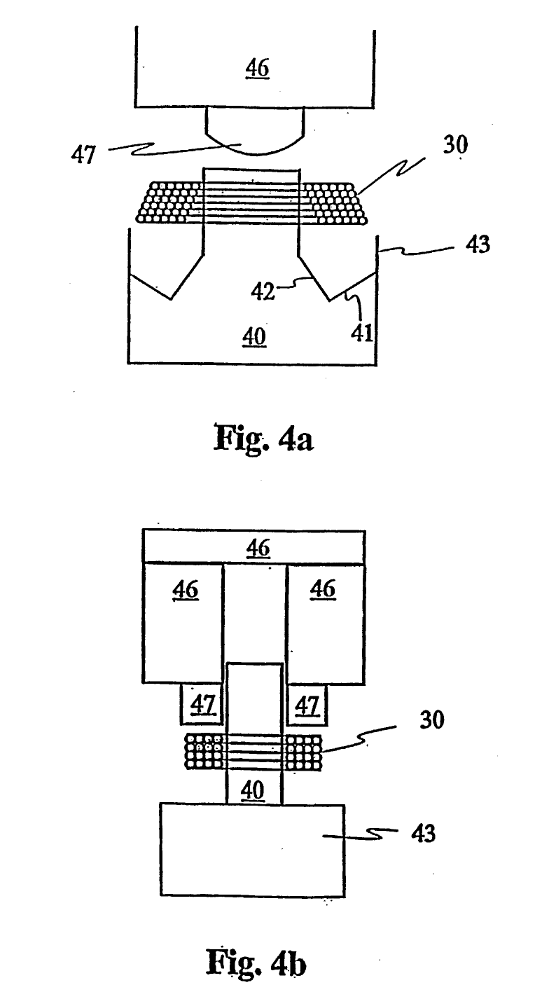

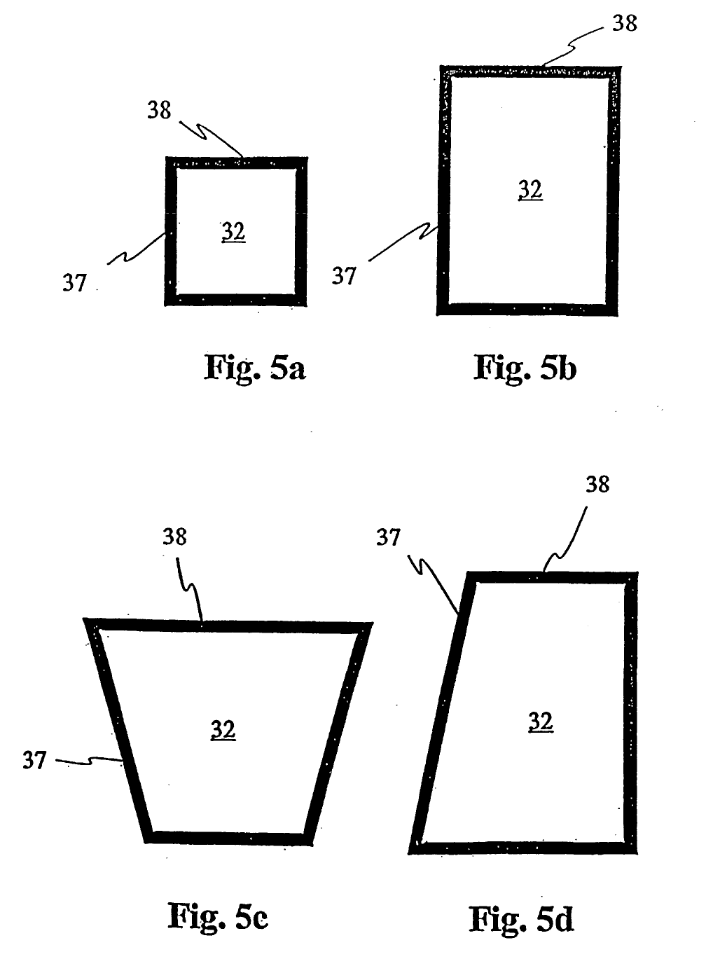

FIG. 4a shows a front view of a bending tool. The bending tool comprises a forming mold 40 and a stamper 46. An intermediate coil 30 is placed in between forming mold 40 and stamper 46 to better illustrate the bending step. The intermediate coil shown in FIG. 3 has been manufactured by winding a circular wire around a winding tool 12 similar to the one shown in FIG. 2a. Seen from above, the intermediate coil has a rectangular shape comprising 4 straight sections (see also FIGS. 5a to d), in particular, two inclined slope sections being parallel to each other and two bow sections which are also parallel to each other.

A side view of the two inclined slope sections of intermediate coil 30 is shown in FIG. 4a and a side view of the two bow sections is shown if FIG. 4b. The number of windings in a wire bundle of each branch of the intermediate coil in FIG. 4a is different than the number of windings in a wire bundle of each branch of the intermediate coil in FIG. 4b. This was done to demonstrate that a huge variety of possible saddle coils can be formed with the disclosed invention. Both figures show a cross sectional view of the same bending tool whereby the viewing angle of the bending tool differs 90°.

The bending tool shown in FIG. 4a comprises a forming mold 40 with a first slope 41 and a second slope 42. When the stamper presses the intermediate coil 30 into the forming mold 40, the interior inclined slope 35 (FIG. 3) of the intermediate coil interacts with the first slope of the forming mold. The downward movement of the stamper causes the interior slope of the intermediate coil 30 to slide along the first slope thereby creating a force directed away from the interior of the coil. This results in a small clockwise rotation of left wire bundle and a small counter clockwise rotation of the right wire bundle. The downward movement of the coil is stopped by the first slope 41 onto which the lower side of the intermediate coil 30 gets to rest. Alternatively, it is also possible to use a bending tool with a first and a second slope being arranged so that the intermediate coil during the bending step interacts with the second slope 42 first and subsequently with the first slope 41. This can be achieved e.g. by extending second slope 42 in FIG. 4a.

The intermediate coil 30 experiences an upwardly directed force caused by the first and second slope 41, 42 which primarily acts on those sections of the intermediate coil which comprise the inclined slopes. At the same time, intermediate coil 30 experiences a downwardly directed force caused by stamper 46 which primarily acts on the bow sections of intermediate coil 30. If a flat intermediate coil is used in the bending step (which is the case in most applications), the bow sections are straight. They are called bow sections since the bow shaped extension 47 of stamper 46 will force these sections to adapt to the bow shape of extension 47.

In FIG. 4a, the forming mold comprises a guiding frame 43 for guiding stamper 40 during its downward moving into forming mold 40. Different to the figure, the guiding frame is preferably higher so that stamper 46 can be inserted into the guiding frame 43 of forming mold 40 before the stamper contacts intermediate coil 30.

FIG. 4b illustrates in particular the shaping action of the bow extensions onto those parts of the wire bundles which connect the two parallel inclined slope sections. During the downward movement of stamper 46, the lowest part of the bow extensions 47 of stamper 46 contacts the wire bundle of intermediate coil 30 first. It contacts the intermediate coil approximately in the center of its bow sections. Then, the coil is forced downward until the inclined slopes of the coil contact the first slope. At that moment, the inclined shaped wire bundles of intermediate coil 30 start to be rotated to the outside and the bow sections of intermediate coil 30 start to be shaped under the influence of bow extension 47. At the end of the downward movement of stamper 46, the lower part of the original intermediate coil rests on first slope 41 and the interior inclined slope of the original intermediate coil rests on the second slope 42. At the same time, bow extensions 47 have formed the straight bow sections of the original intermediate coil 30 into bent bow sections having a shape corresponding to the shape of bow extensions 47.

An exemplary stamper for carrying out the disclosed invention comprises a shaft part and bow shaped extensions. An exemplary forming mold for carrying out the disclosed invention comprises a slope which interacts with the interior slope section of the intermediate coil and, preferably, a further slope for interacting with the underside of the intermediate coil. Bow shaped in the context of this invention includes all shapes which are desirable for a saddle coil and which can be achieved by the interaction of a stamper and a forming mold. In case of more complex shapes of the final saddle coil, several bending steps can be carried out consecutively. With each bending step, the (several) intermediate coils are brought in closer conformity with the desired final shape of the saddle coil. Advantageously, between each bending step heat is provided to the intermediate coil.

FIGS. 5a to 5d show a variety of top views of intermediate coils. All of them comprise four straight sections, two side sections 37 and two bow sections 38. The expression bow sections is derived from their destination of forming the later bowed sections of the saddle coils. The side sections 37 connect the bow sections 38 and at least one of the side sections comprises a inclined slope part which acts as a wire length reservoir during the bending step. In a bent wire bundle, the length of each wire differs depending on its location in the wire bundle. If the bow of a saddle coil is shaped as section of a circle, wires having the same curvature but bigger radii have a bigger length. The inclined slopes in the side sections 37 of the intermediate coils take account of this geometrical requirement of the bow sections 38 and allow the intermediate coils to be bent without risking damage or even rupture of a winding. It should be noted that the bowed sections of a saddle coil do not necessarily have to be circular. Other bowed shapes are also included within the disclosure of this invention.

The side sections 37 in the square shaped and rectangular shaped intermediate coils of FIGS. 5a and 5b are parallel to each other. In such an arrangement it is advantageous to provide both side sections with even slopes if a symmetrically shaped saddle coil shall be manufactured. Nevertheless, it is possible that only one interior side of the intermediate coil comprises a slope or that the slopes on both interior side differ from each other. Such an arrangement can be advantageous if unsymmetrical saddle coils are formed.

The intermediate coils shown in FIGS. 5c and 5d have side sections 37 which are not parallel to each other. In particular the intermediate coil of FIG. 5c has a trapezoid shape. If the bow sections 38 of this intermediate coil are formed in such a way that they have the same curvature but different radii then the resulting saddle coil can closely fit to a inclined shaped object such as an objective lens of a charged particle device. This also applies to the intermediate coil shown in FIG. 5d. The magnetic field of such a saddle coil will, however, not be symmetric to any plane perpendicular to the bow sections 38. With respect to these intermediate coils, the winding tools and the bending tools need to be adapted accordingly.

In the context of this invention, it is not required that the side sections 37 and/or the bow sections of the intermediate coils are straight. They can comprise curvatures or be composed of several straight sections with an angle in between each straight section. Naturally, the winding tools and the bending tools have to be adapted accordingly. Furthermore, it is not necessary that opposing side sections 37 or bow sections 38 have the same shape. Geometrical variations between opposing sections are possible. This gives the manufacturing method disclosed in this invention the flexibility to form also more complex shaped saddle coils. Thereby, care has to be taken that the intermediate coils are provided with inclined slope sections at appropriate positions to compensate for different wire length required by different layers of windings in bowed sections of the desired saddle coil.

The angles at the intersections of side and bow sections in the four intermediate coils shown in FIGS. 5a to 5d are either perpendicular or deviate only a small angle from it. In general, bigger deviations from 90° are not often required. However, in the winding process or for the creation of the magnetic field it can be preferred to round the edges where side and bow sections meet. This reduces the risk of damage of the wire which are wound with tension onto the edges (or corners) of the winding core.

Intermediate coils in accordance with this invention comprise at least one inclined slope section. This inclined slope section is capable of compensating for stress acting on different windings of the intermediate coil during a bending step. The saddle coils manufactured in accordance with this invention are in particular used as miniaturized saddle coils.

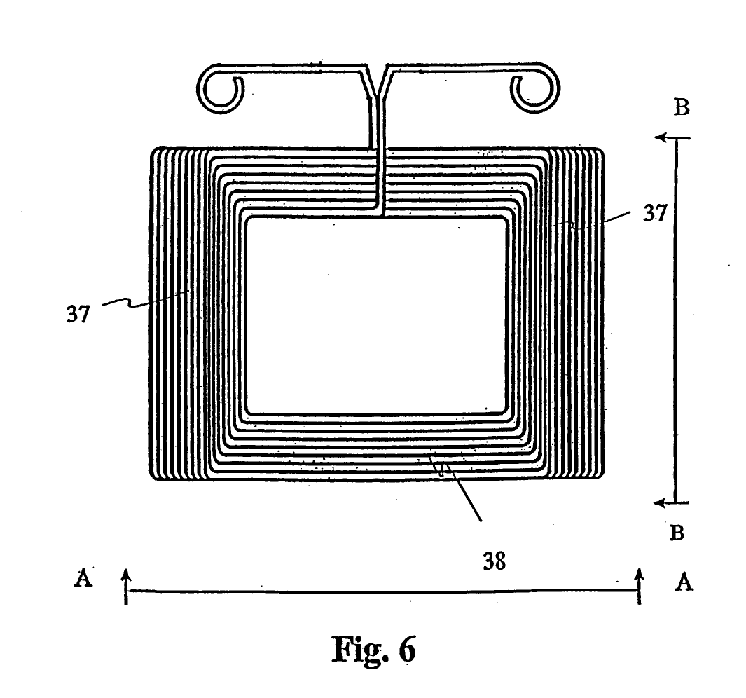

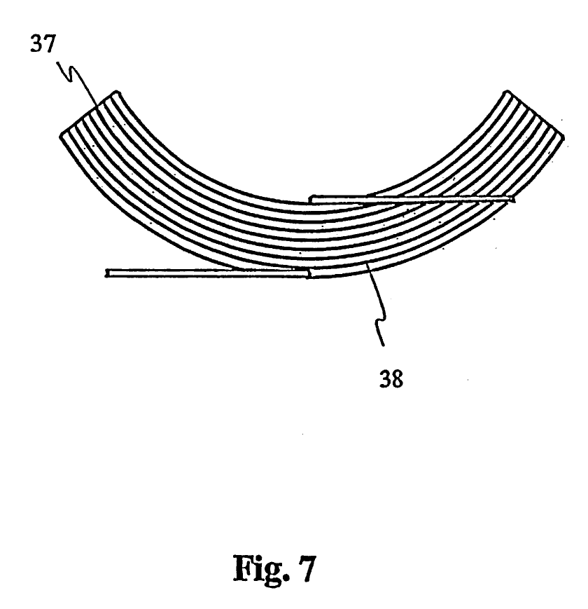

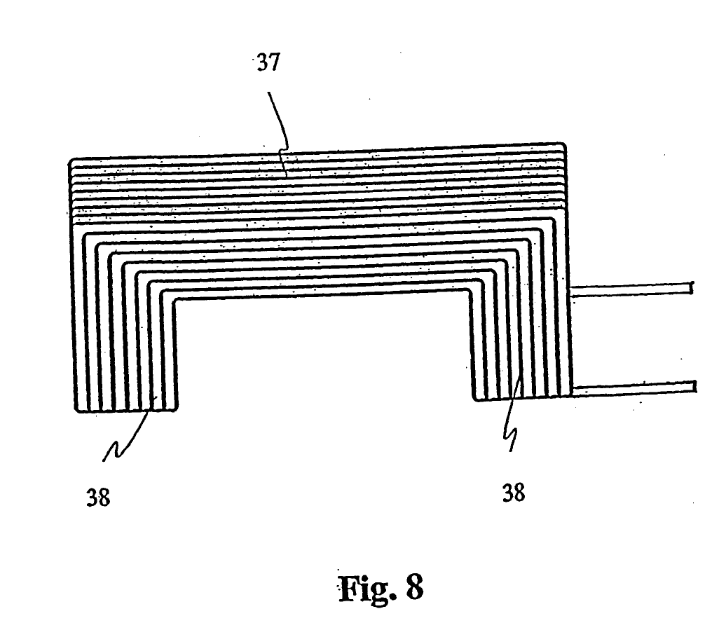

FIG. 6 shows a top view of a saddle coil with bow section 38 being bent into the plane of the drawing paper. FIG. 7 shows a side view of the saddle coil seen from the perspective of line A shown in FIG. 6, whereas FIG. 8 is a side view of the saddle coil seen from the perspective of line B shown in FIG. 6.

1. A method of manufacturing a saddle coil, the method comprising the following steps:
a) winding a conductor around a winding core which is at least partially inclined, thereby forming an intermediate coil;
b) bending the intermediate coil to form the saddle coil.

2. The method of claim 1, whereby the winding core comprises two core side sections, the side sections being inclined.

3. The method of any of the preceding claims, whereby the winding core further comprises two core bow sections, the core bow sections not being inclined.

4. The method of claim 3, whereby the two core bow sections are parallel to each other.

5. The method of any of claims 2 to 4, whereby the two core side sections and the two core bow sections are perpendicular to each other.

6. The method of any of the preceding claims, whereby the intermediate coil is formed as a flat coil.

7. The method of any of the preceding claims, whereby the saddle coil is formed by bending those parts of the intermediate coil which were not formed adjacent the inclined sections of the winding core.

8. A method of manufacturing a saddle coil, the method comprising the following steps:
a) winding a conductor to form an intermediate coil, the intermediate coil comprising is at least one section which is inclined; and
b) bending the intermediate coil to form the saddle coil.

9. A saddle coil, especially manufactured according to any of the preceding claims, obtainable by bending an intermediate coil, the intermediate coil comprising at least one inclined section.

10. The saddle according to claim 9, whereby the intermediate coil comprises at least one rhombic section.
